(19) United States
(12) Patent Application Publication
(10) Pub. No.: US 2012/0022774 A1
(43) Pub. Date: Jan. 26, 2012

(54) SYSTEM AND METHOD FOR AIDING THE IDENTIFICATION AND CONTROL OF AIRCRAFT THAT ARE PRESENT IN AN AIR SECTOR TO BE MONITORED

(75) Inventors: Jean-Philippe PINHEIRO, Sainte Genevieve des Bois (FR); Areski HADJAZ, Montigny Le Bretonneux (FR)

(73) Assignee: THALES, Neuilly-Sur-Seine (FR)

(21) Appl. No.: 13/005,812

(22) Filed: Jan. 13, 2011

(30) Foreign Application Priority Data
Dec. 23, 2009 (FR) 09 06284

(51) Int. Cl. G08G 5/00

(52) U.S. Cl. 701/120

(57) ABSTRACT

The present invention relates to a system for aiding the identification and control of aircraft that are present in an air sector to be monitored. The system includes a voice recognition means for analysing oral communications exchanged between the air-traffic controller and the pilots of aircraft present in the air sector, and a management means for making a comparison between data delivered by the voice recognition means and stored identifiers representative of respective aircraft expected to be present in the air sector.

### CROSS-REFERENCE TO RELATED APPLICATION

The disclosure of foreign French patent application No. FR 09 06284, filed on Dec. 23, 2009, is herein incorporated by reference in its entirety.

### FIELD OF THE INVENTION

The invention relates to a system and a method for aiding the identification and control of aircraft that are present in an air sector to be monitored.

### BACKGROUND OF THE INVENTION

Air-traffic control is a set of services rendered by the air-traffic controllers to the aircraft in order to aid the safe, rapid and efficient execution of the flights. The services rendered are three in number, called air navigation services for the purposes of:
preventing collisions between the aircraft and the ground or the vehicles on the one hand, and collisions in flight between aircraft on the other hand (formerly called “mid-air collisions”). This also consists in accelerating and providing order for the air traffic;
providing advice and information useful for safe and efficient execution of the flight: meteorological information, information on the state of the navigation means on the ground, information on the traffic (when the control service is not provided in this zone); and
providing a warning service in order to warn the appropriate organizations when the aircraft have need of emergency and rescue organizations, and to give these organizations the necessary assistance.

To provide these services, an organization (control tower, en route centre, etc.) is put in place. There are several types of these. Depending on the type of traffic, different organizations provide air-traffic control.

The air-traffic navigation en route centres CRNA are responsible for providing air traffic services for aircraft that are cruising outside the proximity of aerodromes. For example, there are five regional control centres, also called en route centres, in France which share the provision of the control service throughout French territory.

The approach control centres APP are responsible for providing air traffic services in the vicinity of an aerodrome in a control zone the size of which is variable. The air-traffic controllers are usually situated in the look-out post of a control tower, or in a specially arranged radar room.

The aerodrome control centres TWR are responsible for providing the air traffic services in a restricted zone, of the order of some ten kilometres, around an aerodrome. Their main task is the management of the runway. The service is rendered from the look-out post of a control tower.

These organizations have been differentiated because the skills required, the rules applicable and the technical means necessary are not the same. An en route control centre requires a radar, while the main control tool of an aerodrome is sight. On approach, all the aeroplanes wish to go to the same location: the runway; this gives a “funnel” phenomenon. En route, the aeroplanes all have different provenances and destinations, so for many the problems are scattered and random. These differences, and others, have led to this classification.

Since air traffic has increased incessantly since it began, the workload and the number of tasks to be carried out by the air-traffic controllers are increasing in consequence.

### SUMMARY OF THE INVENTION

The invention reduces the workload of the air-traffic controllers that is induced by visually searching for an aircraft on the radar screen, or the workload induced by the selection of information concerning the aircraft.

A system according to the invention for aiding the identification and control of aircraft that are present in an air sector to be monitored includes:

voice recognition means for analysing oral communications exchanged between the air-traffic controller and the pilots of aircraft that are present in the air sector; and

management means suitable for making a comparison between data delivered by the voice recognition means and stored identifiers representative of respective aircraft expected to be present in the air sector.

The management means also being suitable for comparing information entered by the air-traffic controller with data delivered by the said voice recognition means processing oral instructions from the air-traffic controller to the pilots of aircraft.

Such a system limits, e.g., reduces, the workload of the air-traffic controller by automatically attracting the attention of the air-traffic controller to the symbol on the screen representing the aircraft with which the air-traffic controller is in communication. Coupling with predetermined identifiers makes it possible to drastically limit the voice recognition errors due to transmission interference.

Such a system makes it possible to verify the data entered into the system by the air-traffic controller so as to limit the risk of input error.

In an embodiment, the system is furnished with display means for viewing a space comprising the air sector and aircraft that are present in the space, and viewing means on the display means for viewing one aircraft amongst all of the aircraft present, the management means being suitable for dynamically controlling the viewing means to graphically highlight the aircraft the pilot of which is exchanging oral communications with the air-traffic controller based on data delivered by the voice recognition means.

It is also possible for the air-traffic controller to view in real time, on his display screen, the aircraft of the pilot with whom the air-traffic controller is communicating.

In an embodiment, the management means are also suitable for coupling, e.g., comparing and/or correlating, the data delivered by the voice recognition means with a stored flight state of the aircraft displayed on the display means.

This further limits the risk of voice recognition errors due to transmission interference.

Also, the management means are suitable for coupling the said data delivered by the said voice recognition means with at least one stored flight parameter of the aircraft displayed on the display means amongst the altitude, the speed, the heading, the destination, at least one point of the flight plan, the cruising altitude, the vertical speed, the altitude of leaving the air sector, the point of leaving the air sector, and at least one active holding pattern.

The risk of voice recognition errors due to transmission interference is therefore limited.

In an embodiment, the management means are also suitable for entering items of information directly from data delivered by the voice recognition means processing oral instructions from the air-traffic controller to the pilots of aircraft.

It is therefore possible to envisage a voice recognition that is capable of recognizing many instructions or data to be taken into consideration that are spoken by the air-traffic controller when the voice recognition is capable of properly filtering the transmission interference.

In an embodiment, the management means are also suitable for proposing a sub-list of values amongst a list of possible values for a flight parameter of an aircraft based on data delivered by the voice recognition means processing oral instructions from the air-traffic controller to the pilots of aircraft.

Therefore, the controller can save time, notably when he or she has to enter a parameter value into the system, and when the procedure for entering this value offers a drop-down menu having a very large number of possible predetermined values. Specifically, the system can therefore directly open the list of possible values and position it on the range of values corresponding to the oral instruction of the air-traffic controller.

In an embodiment, the management means are suitable for dynamically controlling the viewing means to view an aircraft based on data delivered by the voice recognition means processing an oral request of the air-traffic controller for viewing an aircraft having the identifier of the aircraft.

Therefore, when the controller searches for an aircraft on their screen, they can instantaneously view it by speaking its identifier, as for a search function but in which the input activation would be carried out by voice recognition.

The invention also provides a method for aiding the identification and control of aircraft that are present in an air sector to be monitored, and the method includes:
analysing by voice recognition oral communications exchanged between the air-traffic controller and the pilots of aircraft that are present in the said air sector,
coupling data delivered by said voice recognition and stored identifiers representative of respective aircraft expected to be present in the said air sector, and
comparing information entered by the air-traffic controller with data delivered by the said voice recognition means processing oral instructions from the air-traffic controller to the pilots of aircraft.

In an embodiment, the method further includes viewing the aircraft the pilot of which is exchanging oral communications with the air-traffic controller, amongst the aircraft that are present in the air sector.

### BRIEF DESCRIPTION OF THE DRAWINGS

The above and other aspects, features, and advantages of the present invention will become more readily apparent based on the following detailed description, in which embodiments thereof are described as non-limiting examples, and are illustrated by the accompanying drawings, in which:

FIG. 1 schematically illustrates a station for controlling the air navigation of aircraft according to the invention; and

FIG. 2 schematically illustrates a method for controlling the air navigation of aircraft according to the invention.

### DETAILED DESCRIPTION

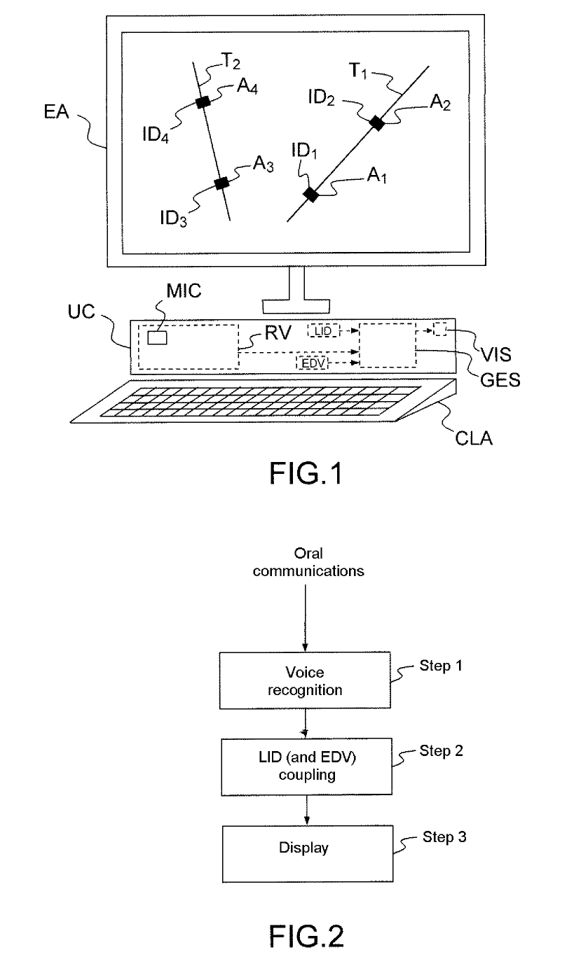

FIG. 1 illustrates an embodiment of a system for controlling the air navigation of aircraft that are present in an air sector to be monitored according to one aspect of the invention. A control station of an air-traffic controller is shown with a keyboard CLA, a central processor unit UC and a display screen EA.

Displayed on the display screen EA is an air space comprising an air sector SA to be monitored by the air-traffic controller, comprising in this example a first possible trajectory T1, on which there are two aircraft A1 and A2 having respectively an identifier ID1 and ID2 displayed, and a second possible trajectory T2 on which there are two aircraft A3 and A4 having respectively an identifier ID3 and ID4 displayed.

The system includes a voice recognition module RV furnished with a microphone MIC for analysing oral communications exchanged between the air-traffic controller and the pilots of aircraft that are present in the said air sector.

The system also includes a management module GES suitable for making a comparison between data delivered by the said voice recognition means RV and stored identifiers LID representative of respective aircraft expected to be present in the air sector SA. Therefore, a list LID of identifiers of the aircraft that are to pass through the air sector SA is compared with the identifiers recognized by the voice recognition module RV, by the management module GES. This makes it possible to drastically limit the risk of recognition error by the voice recognition module RV.

The system may also includes a stored state of the flights EDV of the aeroplanes displayed on the display screen EA, for example an aircraft has an assumed flight state when it is in the air sector SA to be monitored by the controller and a transferred flight state when it is displayed on the display screen EA, but transferred to another air sector to be monitored by another air-traffic controller.

A viewing module VIS makes it possible to view an aircraft on the display screen EA, for example by displaying it in a different colour from the display of the other aircraft. The management module GES is suitable for dynamically controlling the viewing means VIS in order to view the aircraft the pilot of which is exchanging oral communications with the air-traffic controller based on data delivered by the voice recognition module RV. Therefore, in real time, the air-traffic controller can view on the screen the aircraft with which he is exchanging communications.

The management module GES can, for example, be used to directly enter information based on data delivered by the said voice recognition means RV processing oral instructions from the air-traffic controller when the error ratio of the voice recognition RV is very low.

The management module GES can, for example, compare items of information saved by the air-traffic controller based on data delivered by the said voice recognition means RV processing oral instructions from the air-traffic controller. Therefore, the management module can compare data typed on the keyboard CLA by the air-traffic controller with the data that he has spoken, and thus detect any typing faults on the keyboard CLA, and detect possible errors.

The management module GES can, for example, propose a sub-list of values amongst a list of possible values for a flight parameter of an aircraft based on data delivered by the voice recognition means RV processing oral instructions from the air-traffic controller. Therefore, the controller can save time, notably when he has to enter a parameter value into the system, and the input procedure for this value proposes a drop-down menu comprising a very large number of possible predetermined values. The system then directly displays the range of values concerned.

The management module GES can dynamically control the viewing module VIS in order to view an aircraft based on data delivered by the said voice recognition means RV on an oral request from the air-traffic controller in order to view an aircraft by speaking the identifier of the aircraft.

FIG. 2 illustrates a method according to an embodiment of the invention.

The oral communications exchanged between the air-traffic controller and the pilots of aircraft that are present in the air sector SA to be monitored are processed by voice recognition in a step 1 by the voice recognition module RV.

A coupling with a list of identifiers LID and optionally with a state of the stored flights EDV is carried out in a step 2 to drastically limit the recognition errors.

Other couplings are possible, for example with the altitude and/or the heading and/or the speed and/or the flight phase. Specifically, if an aircraft is in the climbing phase, and its altitude is 17000 ft, if the controller gives a new altitude, the latter will necessarily be greater than 17000 ft. Therefore, this coupling makes it possible to reduce the field of investigation of the voice recognition: the analysis on the order must produce a value greater than 17000 ft.

The result is displayed on the display screen EA during a third step.

Thus, the present invention substantially improves the working conditions of an air-traffic controller and significantly decreases the possibilities of the air-traffic controller making errors.

What is claimed is:

1. A system for aiding the identification and control of aircraft present in an air sector to be monitored, said system comprising:
voice recognition means for analysing oral communications exchanged between the air-traffic controller and the pilots of the aircraft present in the air sector; and
management means for making a comparison between data delivered by the voice recognition means and stored identifiers representative of respective aircraft expected to be present in the air sector, said management means also for comparing information entered by the air-traffic controller with data delivered by the voice recognition means processing oral instructions from the air-traffic controller to the pilots of aircraft.

2. The system according to claim 1, further comprising:
display means for viewing a space comprising the air sector and aircraft present in the air sector; and
viewing means on said display means for viewing one aircraft amongst all of the aircraft present, wherein said management means is suitable for dynamically controlling said viewing means to graphically highlight the aircraft the pilot of which is exchanging oral communications with the air-traffic controller based on data delivered by said voice recognition means.

3. The system according to one claim 1, wherein said management means is suitable for coupling said data delivered by said voice recognition means with a stored flight state of the aircraft displayed on said display means.

4. The system according to claim 1, wherein said management means is suitable for coupling said data delivered by said voice recognition means with at least one stored flight parameter of the aircraft displayed on said display means, said flight parameters including the altitude, the speed, the heading, the destination, at least one point of the flight plan, the cruising altitude, the vertical speed, the altitude of leaving the air sector, the point of leaving the air sector, and at least one active holding pattern.

5. The system according to claim 1, wherein said management means is suitable for entering items of information directly from data delivered by said voice recognition means processing oral instructions from the air-traffic controller to the pilots of aircraft.

6. The system according to claim 1, wherein said management means is suitable for proposing a sub-list of values amongst a list of possible values for a flight parameter of an aircraft based on data delivered by said voice recognition means processing oral instructions from the air-traffic controller to the pilots of aircraft.

7. The system according to claim 2, wherein said management means is suitable for dynamically controlling said viewing means to view an aircraft based on data delivered by said voice recognition means processing an oral request of the air-traffic controller for viewing an given aircraft having the identifier of said aircraft.

8. A method for aiding the identification and control of aircraft present in an air sector to be monitored, said method comprising:
Analysing, by voice recognition, oral communications exchanged between an air-traffic controller and pilots of the aircraft present in said air sector;
coupling data delivered by said voice recognition and stored identifiers representative of respective aircraft expected to be present in said air sector; and
comparing information entered by the air-traffic controller with data delivered by said voice recognition means processing oral instructions from the air-traffic controller to the pilots of aircraft.

9. The method according to claim 8, further comprising graphically highlighting the aircraft the pilot of which is exchanging oral communications with the air-traffic controller, amongst the aircraft that are present in said air sector.
